(19) United States
(12) Patent Application Publication
(10) Pub. No.: US 2026/0175309 A1
(43) Pub. Date: Jun. 25, 2026

(54) BATTERY POWERED WELDING SYSTEM AND CART

(71) Applicant: HARDER MECHANICAL CONTRACTORS, INC., Portland, OR (US)

(72) Inventors: Robert T. FLESKES, Scottsdale, AZ (US); Adam MUMFORD, New River, AZ (US); George Washington STEPHENS, Payettte, ID (US)

(21) Appl. No.: 19/423,614

(22) Filed: Dec. 17, 2025

Related U.S. Application Data
(60) Provisional application No. 63/736,456, filed on Dec. 19, 2024.

(51) Int. Cl. B23K 9/10; A62C 3/07; A62C 3/16; B23K 9/32; H01M 10/613; H01M 10/625; H01M 10/6562; H01M 50/242; H01M 50/249

(52) U.S. Cl. CPC B23K 9/105; A62C 3/07; A62C 3/16; B23K 9/1081; B23K 9/327; H01M 10/613; H01M 10/625; H01M 10/6562; H01M 50/242; H01M 50/249

(57) ABSTRACT

A battery-powered welding system includes a battery energy storage unit, a welding machine, and a switching control unit supported on a cart. The switching control unit controls an output of the battery energy storage unit coupled to the welding machine. A power input receptacle is mounted or otherwise supported on the cart for receiving a power coupling to an external power source for charging the battery energy storage unit when not in use. The battery capacity is sufficient to provide more than a full workday of normal usage of the welding system, thereby avoiding interruptions and fluctuations of external power sources. The welding system may include a charging station for charging the battery energy storage unit.

### RELATED APPLICATIONS

This application is a nonprovisional of and claims the benefit under 35 U.S.C. §119(e) from U.S. Provisional Ser. No. 63/736,456 , filed Dec. 19, 2024, the disclosure of which is incorporated by reference herein in its entirety.

### TECHNICAL FIELD

The field of the present disclosure generally relates to welding systems and, in particular, to mobile welding systems including welding machines powered by electricity, such as mobile orbital tungsten inert gas (TIG) welding systems and other mobile arc welding systems.

### BACKGROUND

Industrial welding machines and systems, such as industrial arc welding systems (including tungsten inert gas (TIG), stick, and wire-feed systems), may require substantial amounts of electrical input power to operate. Weld quality may vary with the input power conditions, weld controller setup, base material, joint shape, filler material, flux material, and other variables. Prior to beginning production, weld coupons are commonly prepared and tested to assist in adjusting weld variables as needed and to confirm proper setup and weld quality. The tested coupons are then checked from inside out using either destructive or non-destructive test methods to ensure the weld fully penetrated the joint and is free of defects. Preparation and testing of weld coupons is tedious and time consuming, and reduces the amount of time the welder spends on production.

When the electrical energy input to a welding machine fluctuates during the welding process, the poor-quality input power (aka “dirty power”) can lead to weld machine output fluctuations that produce welds which fail inspection. On some job sites, input power interruptions and fluctuations are common due to many simultaneous loads on the job site's power distribution systems and/or due to reliance on diesel generators and/or other sources of dirty power.

Automatic orbital gas tungsten arc welding systems (also known as orbital GTAW systems or orbital TIG systems) are a specialized type of arc welding equipment commonly used for joining tubes, such as stainless-steel tubing, used for gas and liquid distribution. When welding tubing at a job location, a weld that does not pass inspection, for example due to input power interruptions or fluctuations, must be cut out and replaced with two new welds, leading to a very significant loss of productivity, because three welds were required to be made rather than one.

In some industries, such as the semiconductor and pharmaceutical industries, extremely precise orbital welds are required to ensure that joints are leak-free to avoid leakage of dangerous chemicals and crevice free to eliminate any entrapment areas on the inner diameter of the weld joint which could cause contamination and/or generate particulate matter that adversely affects the downstream processing equipment and quality of the manufactured products, such as semiconductor circuits or pharmaceuticals. To ensure a series of high-quality and consistent orbital welds across a long distance in which numerous tubes are joined in series by welds, a “coupon in/coupon out” procedure may be utilized. When a welder begins their work, they “coupon in”—i.e., produce an initial test coupon—to demonstrate that the settings on the welding power unit are correct for the size and specification of the material to be welded. At the end of a series of welds, the welder will “coupon out”—i.e., produce a final test coupon—to check that the weld quality at the end of the job is not significantly worse than at the beginning, which is a rudimentary way of verifying that the weld quality has not degraded during the production session. If the work on a tubing line covers a long distance, then the weld machine may be supported on a cart so that it can be moved from one location to the next. However, in such configurations, the welding machine will need to be unplugged before being moved to a new location along the line, and then plugged in again at the new location, which may lead to inconsistencies in the input power. To ensure consistency of the welds, the welder must coupon-out before unplugging the welding machine and then coupon-in again once the welding system is at its new location, leading to further loss of production time when using this process.

Thus, the present inventor has recognized a need for cleaner and more consistent sources of electrical input power for a welding system, which helps reduce weld quality issues and loss of production time due to frequent quality control measures, such as “coupon-in/coupon-out” procedures. Additional aspects and advantages will be apparent from the following detailed description of preferred embodiments, which proceeds with reference to the accompanying drawings.

### BRIEF DESCRIPTION OF THE DRAWINGS

The drawings depict only several examples in accordance with the disclosure and are therefore not to be considered limiting in scope. Example embodiments will be described with additional specificity and detail through use of the accompanying drawings, in which:

FIG. 1 illustrates a welder's cart in accordance with one prior art configuration.

FIG. 2 is a front pictorial view of a cart-mounted mobile welding system according to the present disclosure.

FIG. 3 is an oblique left-side pictorial view of the welding system of FIG. 2 showing detail of an armored battery energy storage unit of the welding system.

FIG. 4 is an oblique left-side view of the welding system of FIG. 2 with an armored housing omitted to show details of the battery energy storage unit.

FIG. 5 is a front pictorial view of the welding system of FIG. 2 with the armored housing omitted to show details of the battery energy storage unit.

FIG. 6 is a rear pictorial view of the armored battery energy storage unit of FIG. 3, showing a vent opening in the rear of the armored housing, with a vent panel of the armored housing removed to show the battery energy storage unit.

FIG. 7 is a right-side pictorial view of the welding system of FIG. 2.

FIG. 8 is a right-side pictorial view of the welding system of FIG. 2 with an adapter extension cable of the welding system omitted to show detail of a switching control unit for the battery energy storage unit.

FIG. 9 is an oblique, rear right-side view of the welding system of FIG. 2.

FIG. 10 is an enlarged oblique, rear right-side detail view of the welding system of FIG. 2 showing a main power disconnect switch and conduit of the welding system.

FIG. 11 is a simplified schematic view of a cart-mounted mobile welding system including a charging station capable of charging a battery of the welding system in accordance with an example embodiment.

FIG. 12 is a single-line diagram illustrating an electrical power system of the mobile welding system of FIG. 11 in accordance with an example embodiment.

FIG. 13 is a single-line diagram for electrical wiring associated with an up-step transformer for charging the battery of the welding system of FIG. 11.

FIG. 14 is a simplified schematic view of a cart-mounted mobile welding system including a charging station capable of charging a battery of the welding system in accordance with an example embodiment.

To easily identify the discussion of any particular element or act, the most significant digit or digits in a reference number refer to the figure number in which that element is first introduced.

### DETAILED DESCRIPTION OF EXAMPLE EMBODIMENTS

Reference will now be made in detail to embodiments, examples of which are illustrated in the accompanying drawings. Throughout the specification, reference to “one embodiment,” “an embodiment,” or “some embodiments” means that a described feature, structure, or characteristic may be included in at least one embodiment of a battery powered welding cart. Thus, appearances of the phrases “in one embodiment,” “in an embodiment,” or “in some embodiments” in various places throughout this specification are not necessarily all referring to the same embodiment. Further, the described features, structures, and characteristics may be combined in any suitable manner in one or more embodiments. In the following detailed description, numerous specific details are set forth to provide a sufficient understanding of the subject matter presented herein. It should be understood that in some instances, well-known structures, materials, or operations are not shown or described in detail to avoid obscuring more pertinent aspects of the embodiments. In addition, although the embodiments may illustrate and reference specific designs, it will be apparent to one of ordinary skill in the art that the subject matter may be practiced without some of these specific details or in combination with other components not described herein.

The disclosure generally relates to mobile welding systems with an orbital arc welding system mounted on a wheeled pushcart. However, various inventions and features described herein may be useful with different types of electrically powered welding systems and different kinds of conveyance vehicles.

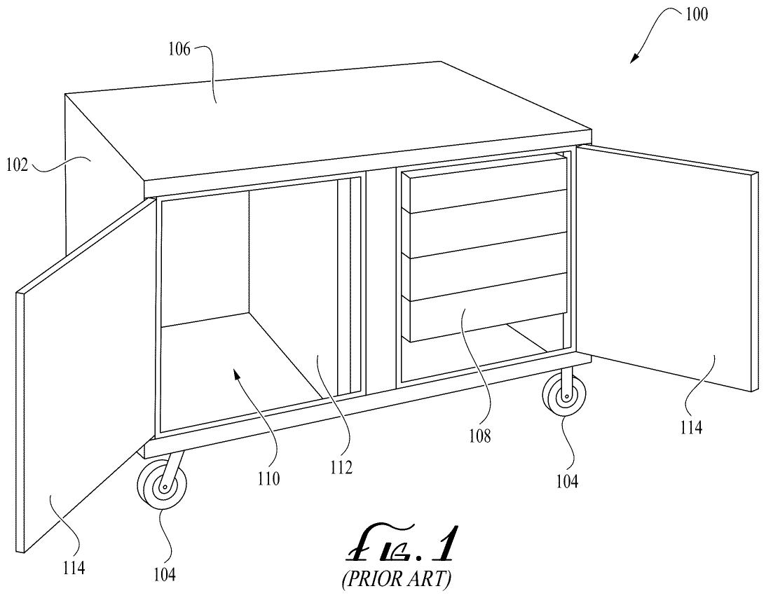

FIG. 1 illustrates a prior-art welder's workstation in the form of a welding cart 100 having a cabinet 102 mounted on casters 104 that allow the cart 100 to be pushed from one location to another within a job site. The cart 100 includes a work surface 106 on the top of cabinet 102 and drawers 108 and other storage space 110 within cabinet 102. Cabinet 102 may include a divider wall 112 that provides support for drawers 108 and work surface 106. A pair of doors 114 allows the drawers 108 and storage space 110 to be secured when the cart is not in use.

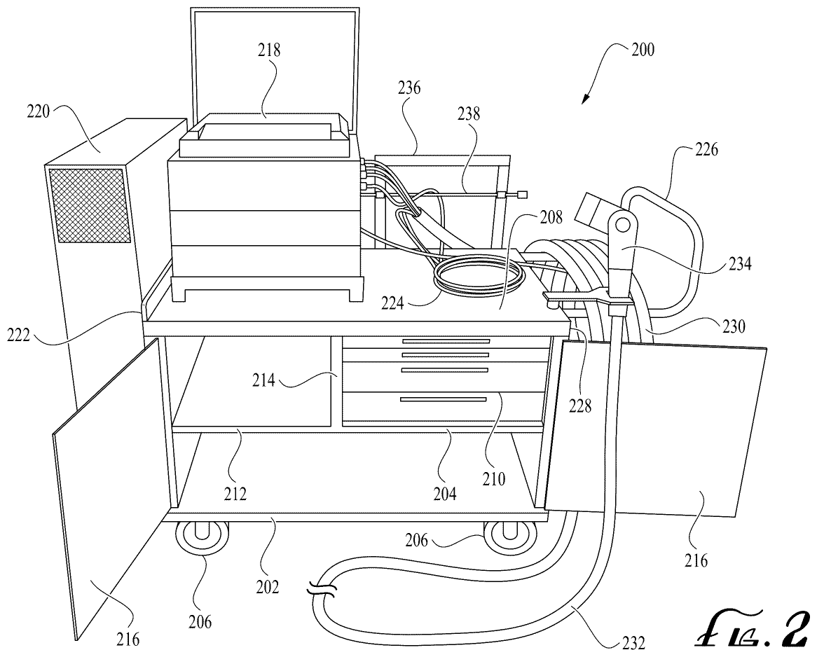

FIG. 2 illustrates a mobile welding system 200 in accordance with one embodiment. With reference to FIG. 2, welding system 200 includes a cart 202 that may be the same as or similar to the prior art welding cart 100 of FIG. 1. In the embodiment illustrated, cart 202 includes a cabinet 204 mounted on casters 206 (e.g., wheels or other suitable device for facilitating cart mobility), a work surface 208, drawers 210, storage shelves 212, a vertical dividing wall 214 and doors 216. Welding system 200 further includes a welding machine 218 (also known as a welding power source or weld controller) supported on the work surface 208. A battery energy storage unit 220 of the welding system 200 is coupled to or otherwise attached to a first side panel 222 of the cart 202. FIG. 2 illustrates the battery energy storage unit 220 attached to the left side panel 222. In other configurations, the battery energy storage unit 220 may instead be attached to an opposite right-side panel (e.g., panel 228) or any other panel of the welding cart 202.

The battery energy storage unit 220 may be a modular battery energy storage unit of the type utilized in residential home power backup systems. The battery energy storage unit 220 delivers electrical power to welding machine 218 (aka a welding power supply) via a power cable 224. When fully charged, the battery energy storage unit 220 provides a clean source of power that can operate the welding machine 218 for a period of days without needing to be recharged. For example, the battery energy storage unit 220 may have an energy storage capacity of more than 10 kilowatt hours (kWh) and preferably more than 13 kWh or more than 15 kWh, and preferably between 13 kWh and 20 kWh, with a peak output between 7 kW and 10 kW or more, a continuous output capability of 5 kW to 8 kW or more, and a maximum continuous current output of 20 Amps (A) or more and preferably 24 A or more.

Battery energy storage unit 220 may include an automatic shut-off feature which disables power output when the remaining percentage of charge drops below a first predetermined threshold, such as when the remaining charge reaches a 10% threshold, for example. In some embodiments, a notification or alarm may be provided by the battery energy storage unit 220 or other component of the system when the remaining charge of the battery energy storage unit 220 drops below a second predetermined threshold higher than but nearing the first predetermined threshold, such as 15% remaining charge for example, to alert the user that the system will soon shut down. In one configuration, the battery energy storage unit 220 may be capable of outputting 220 V and 30 A for an output power of 6.6 kW. Many different output voltage and current configurations are possible, and may be configured for any of various types of welding machines that may be utilized with welding system 200.

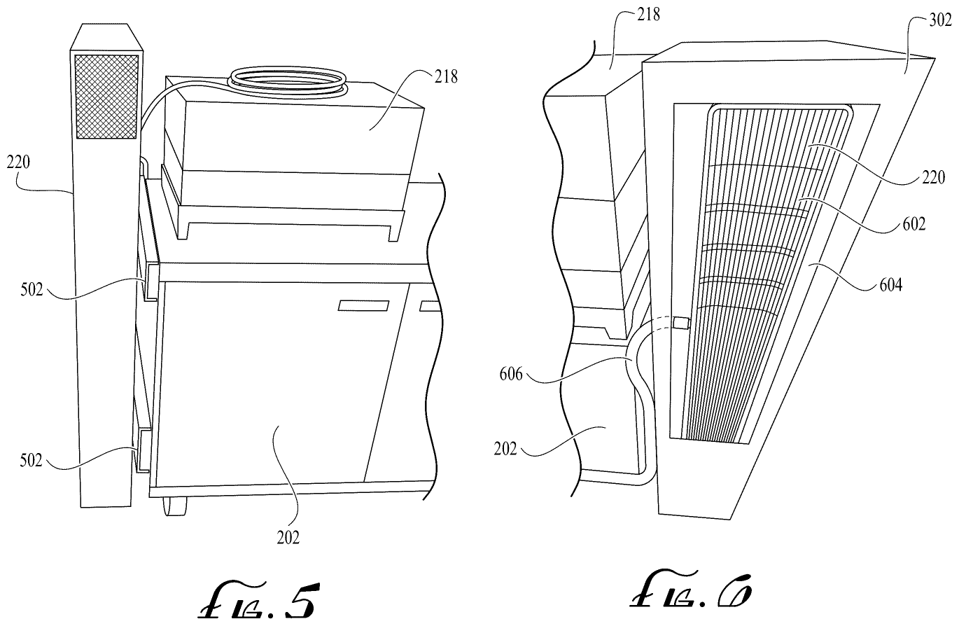

The battery energy storage unit 220 may include a primary housing 402 (see FIG. 4) that contains numerous lithium-ion battery cells, such as lithium nickel manganese cobalt oxide (NMC) lithium-ion batteries or lithium iron phosphate (LiFePo4) lithium-ion batteries, for example. Battery energy storage unit 220 may be approximately 5 to 8 inches thick, 3 to 4 feet tall, and weigh approximately 100 to 250 pounds (lbs.) or more. Although battery energy storage unit 220 is mounted to a first side panel 222 of cart 202 in the embodiment illustrated, in other embodiments the battery energy storage unit may be housed and/or mounted within the cabinet 102 or mounted to a rear side (or any other suitable side or portion) of cabinet 102.

A hanger 226 is coupled or otherwise mounted to a second side panel 228 (such as the right-side panel in the embodiment illustrated) of the cart 202 and is adapted for carrying a coiled adapter extension cable 230 that couples the welding machine 218 to a weld head cable 232 of a welding head 234. In the embodiment illustrated, the welding head is an automatic orbital TIG welding head. A support frame 236 is attached to the upper portion of the rear of the cabinet 204 and supports a welding gas manifold 238 for delivering inert welding gas to the welding head 234, optionally via the welding machine 218. Welding gas manifold 238 may include gas flow controls and moisture traps. In some embodiments, the welding gas manifold 238 may also deliver the inert welding gas to other tools or for other purposes in addition to welding machine 218. Hanger 226 may double as a handle for pushing or pulling the cart 202 to move the cart from one location to another.

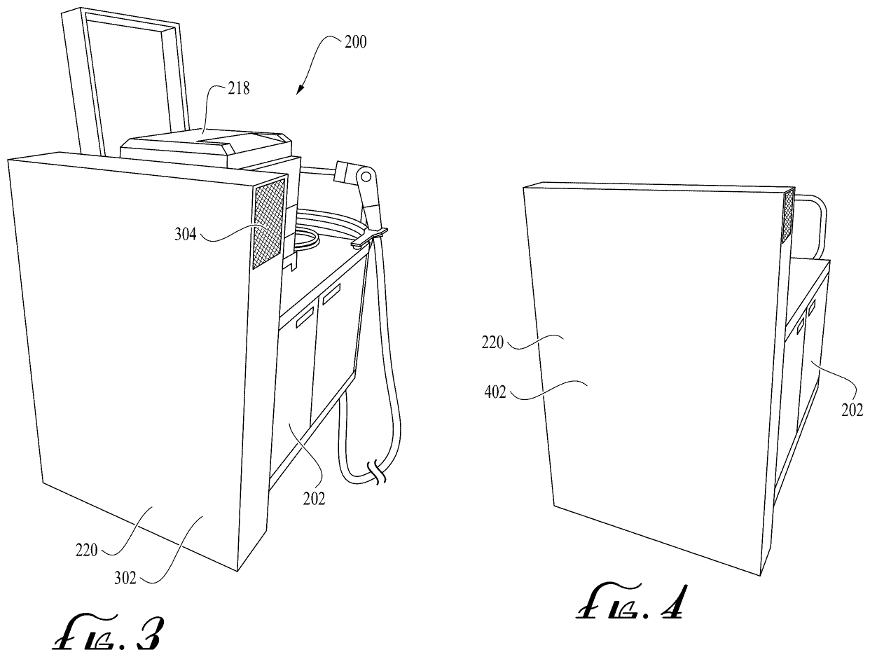

FIG. 3 is a side view showing detail of the battery energy storage unit 220 and its armored housing 302 which includes a front air intake vent 304. FIG. 4 and FIG. 5 are respective left-side and front views showing the battery energy storage unit 220 with the armored housing 302 removed to reveal a primary housing 402 of the battery energy storage unit 220. A pair of horizontal mounting bars 502 coupled to the cart 202 are shown in FIG. 5. The bars 502 collectively provide a secure platform for removably mounting the battery energy storage unit 220 to first side panel 222 at two different height locations as desired.

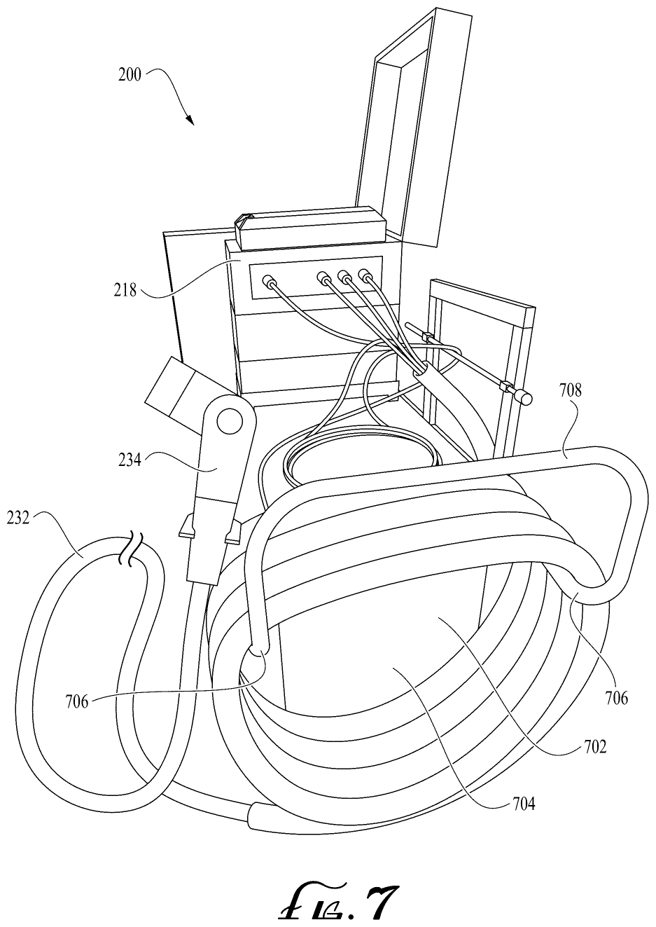

FIG. 6 is a rear view of the battery energy storage unit 220 showing a vent opening 604 formed in a rear side 602 of the armored housing 302. A vent grille (not illustrated) covering vent opening 605 is removed from the vent opening 604 in the view shown. Vent 304 in FIG. 3 and vent opening 604 cooperate to allow a cooling airflow through battery energy storage unit 220. Some embodiments may include an emergency fire suppression system (not illustrated) located within the armored housing 302 and/or within primary housing 402. The emergency fire suppression system may emit a flame retarding aerosol, smothering foam, or another fire-mitigating substance in response to it detecting (e.g., via sensors or other suitable means) a fire in the battery energy storage unit 220.

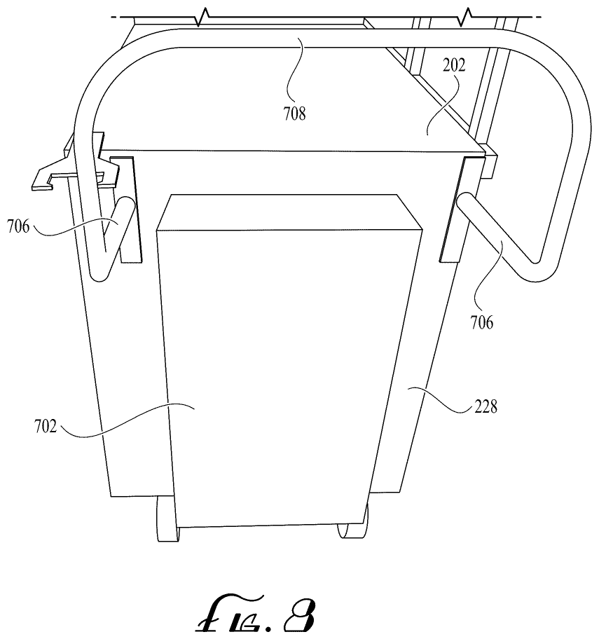

A conduit 606 is shown connected to battery energy storage unit 220. Conduit 606 electrically couples the battery energy storage unit 220 to a switching control unit 702 described below with reference to FIG. 7.

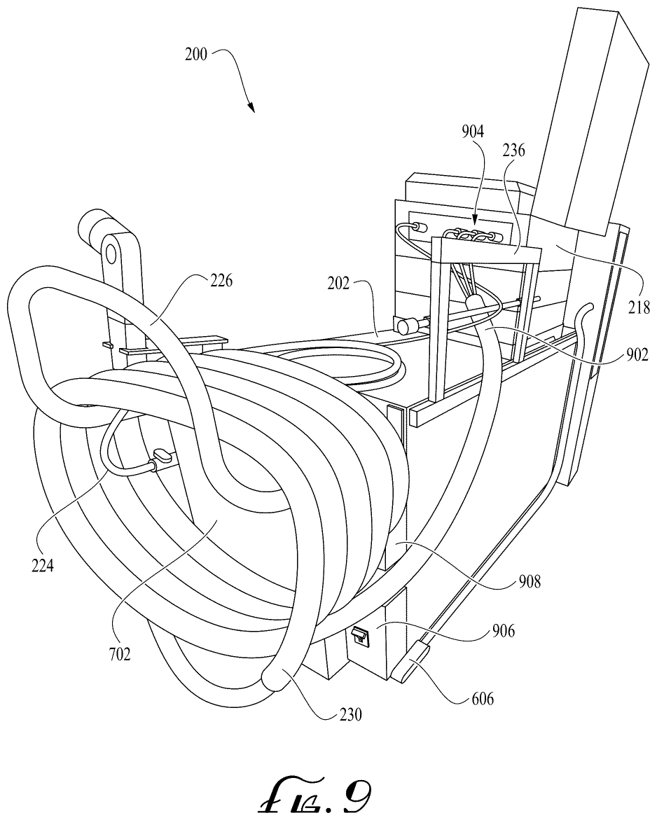

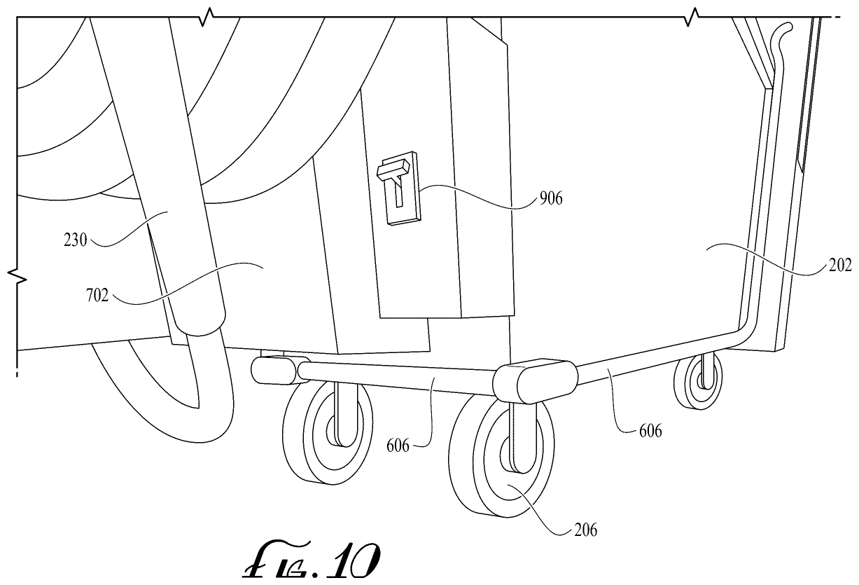

Turning now to FIG. 7, the switching control unit 702 is mounted to a second side panel 228 of cart 202 (e.g., a right-side wall in the embodiment illustrated) between where two arm portions 706 of the hanger are mounted to second side panel 228. The hanger 226 extends outwardly beyond switching control unit 702 to form a handle portion 708 that both serves as a push/pull handle for maneuvering the cart 202 and protects the switching control unit 702 from damage due to collisions. When the adapter extension cable 230 is coiled around hanger 226 as illustrated, the adapter extension cable 230 further protects the switching control unit 702 from damage. FIG. 7 illustrates the switching control unit with a shroud 704 in place, whereas shroud 704 is omitted in FIG. 8. FIG. 8 is a partially assembled view that also omits electrical connections between the switching control unit 702 and the battery energy storage unit 220, and a main disconnect switch 906 and power input receptacle 908 described below with reference to FIG. 9.

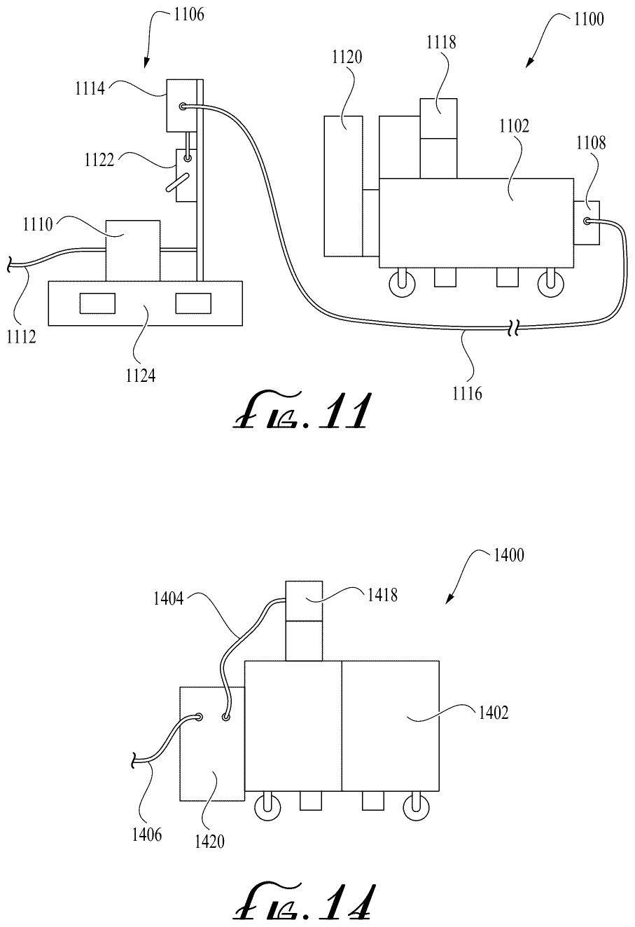

Turning now to FIG. 9, a proximal end 902 of the adapter extension cable 230 is shown with its adapter plugs 904 connected to welding machine 218. An opposite distal end of the adapter extension cable 230 is connected to the weld head cable 232 of the welding head 234 (see FIG. 2). A power input receptacle 908 is mounted to or otherwise supported on the cart 202 adjacent the switching control unit 702. In one embodiment, the power input receptacle 908 may be supported on the cart, such as by being housed within the cabinet 204. The power input receptacle 908 may be electrically coupled to the switching control unit 702 and is adapted to receive a power coupling (not illustrated) that connects to an external power source (see FIGS. 11-13 for example) for charging the battery energy storage unit 220. In some embodiments, the switching control unit 702 and the power input receptacle 908 may be integrated into a single system. A main disconnect switch 906 is preferably interposed between the power input receptacle 908 and the switching control unit 702 and manually operable to disconnect the battery energy storage unit 220 from the power input receptacle 908 when an external power source is not connected to the power input receptacle 908, thereby preventing accidental discharge of power via the power input receptacle 908 and controlling the source of power supplied to the welding machine 218. In an alternative embodiment, a power sensing circuit and/or overcurrent breaker may be used in place of disconnect switch 906 to disconnect the power input receptacle 908 from the battery energy storage unit 220 when an external power source is not connected. One or more outlet sockets may be mounted on switching control unit 702, or on cart 202 and coupled to switching control unit 702, for providing one or more 110 V and/or 220 V output receptacles to which welding equipment may be plugged in for supplying electrical power from battery energy storage unit 220 to the welding equipment. For example, the power cable 224 of welding machine 218 may be plugged into such a 110 V or 220 V output receptacle.

FIG. 10 provides an enlarged view of the disconnect switch 906 and of the conduit 606 which connects the battery energy storage unit 220 to the switching control unit 702. As shown, conduit 606 is routed downwardly from the battery energy storage unit 220 and then extends along a lower edge of a rear wall of the cabinet 204, and turns a corner to run along the second side panel 228 where the conduit 606 is coupled to the switching control unit 702.

FIG. 11 is a simplified schematic view of a cart-mounted mobile welding system 1100 designed for charging a battery 1120 of the welding system 1100 in accordance with an example embodiment. With reference to FIG. 11, the cart-mounted mobile welding system 1100 may include many of the same or similar elements arranged and operating in the same or similar fashion as previously described with respect to the cart-mounted mobile welding system 200 of FIGS. 2-10. Accordingly, some features of the cart-mounted mobile welding system 1100 may be described briefly or otherwise omitted in the following description to avoid obscuring more pertinent features of the embodiment with the understanding that features described with reference to cart-mounted mobile welding system 200 of FIGS. 2-10 may also apply to cart-mounted mobile welding system 1100.

Briefly, the cart-mounted mobile welding system 1100 includes a cart 1102 supporting a welding machine 1118 (also known as a welding power source or weld controller) on a surface thereon, and a battery energy storage unit 1120 mounted to or otherwise supported on or by the cart 1102, the battery energy storage unit 1120 operable to deliver electrical power to the welding machine 1118. The cart 1102 has the same or similar features as the cart 202 of FIG. 2. Likewise, the welding machine 1118 and the battery energy storage unit 1120 have the same or similar features as the respective welding machine 218 and the battery energy storage unit 220 of FIG. 2. These components are designed to operate in a similar fashion as described with reference to the previous example embodiment of the cart-mounted mobile welding system 200.

With reference to FIG. 11, the cart-mounted mobile welding system 1100 further includes a gateway and power input receptacle 1108 mounted to or otherwise support on the cart 1102, the gateway and power input receptacle 1108 electrically coupled to the battery energy storage unit 1120 and operable to deliver power thereto to charge the battery energy storage unit 1120 as needed. As illustrated in FIG. 11, the cart-mounted mobile welding system 1100 further includes a charging system 1106, which may be supported on a surface 1124 that may be separate from the cart 1102. For example, in one embodiment, the surface 1124 may be part of a steel pallet (not shown) supporting some or all of the components of the charging system 1106. The steel pallet may include forklift slots and/or lifting lugs to help facilitate transportation of the charging system 1106 as needed. In other embodiments, some or all of the components of the charging system may be supported by or on the cart 1102. The charging system 1106 includes a transformer 1110 that receives electrical power, such as via a power cord 1112 (e.g., a 480V power cord) electrically coupled to an external power source (not shown). The transformer 1110 transfers the electrical power from the external power source to a breaker panel 1114, which is in turn electrically coupled to the gateway and power input receptacle 1108 via a power cord 1116 (e.g., a 240V power cord). In this arrangement, the cart-mounted mobile welding system 1100 may use electrical power from an external power source to charge the battery energy storage unit 1120 via the gateway and power input receptacle 1108 that is coupled thereto. As illustrated, the charging system 1106 also includes a disconnect 1122 operable to shutoff electrical power delivered to the breaker panel 1114 to isolate the power supply for safety and maintenance purposes as needed.

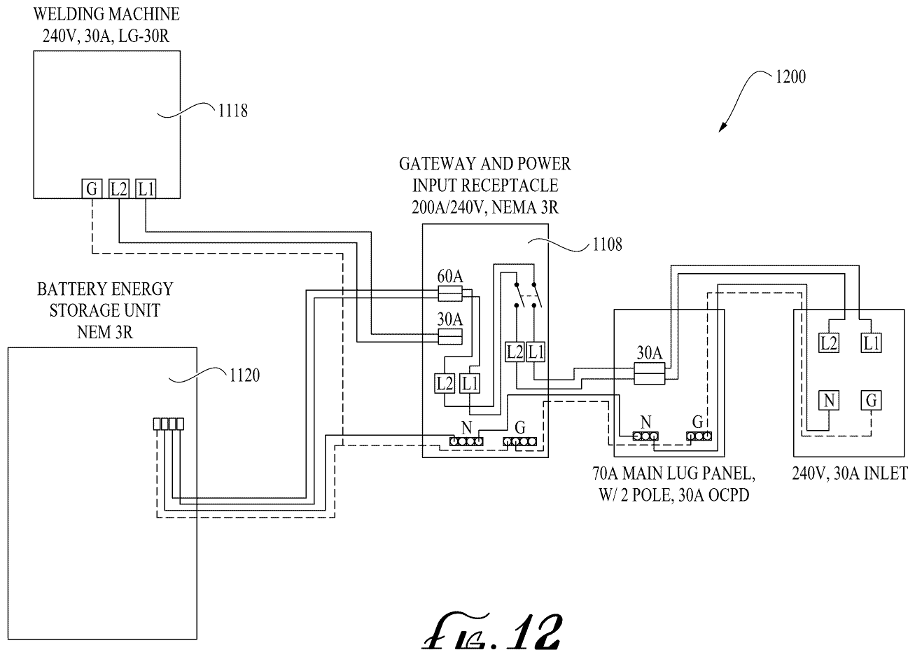

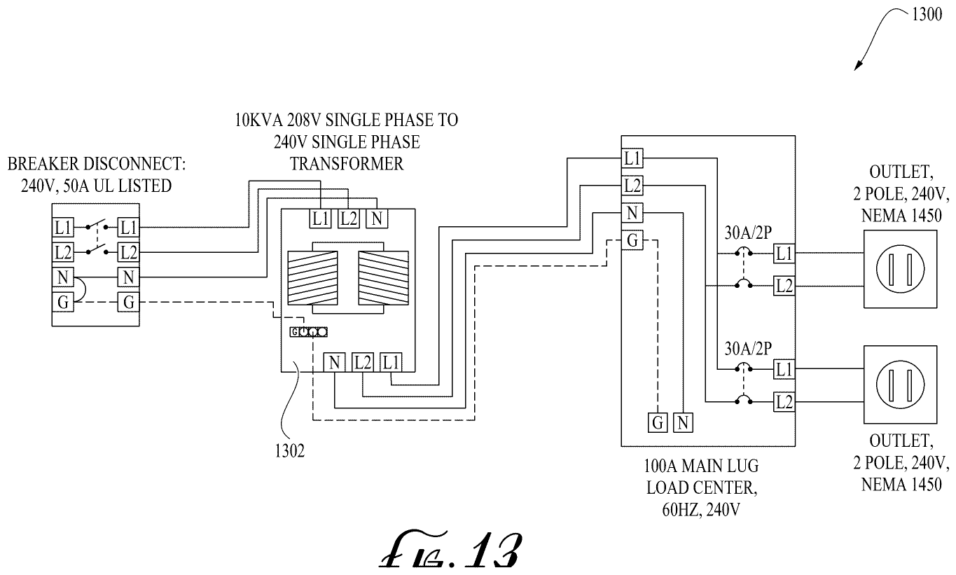

FIG. 12 is an example single-line diagram 1200 illustrating an electrical power system of the cart-mounted mobile welding system 1100 of FIG. 11 in accordance with an example embodiment. FIG. 13 is a single-line diagram 1300 for electrical wiring associated with a step-up transformer 1302 for charging the battery of the welding system of FIG. 11. In some embodiments, the battery (e.g., battery energy storage unit 1120) may not be compatible with 208V power that may be commonly available at workplaces and other sites. Accordingly, the charging system (e.g., charging system 1106) would not be able to charge the battery on location. In such configurations, the step-up transformer 1302 is configured to increase the 208V power input into 240V power output as illustrated in the single-line diagram 1300 of FIG. 13 to properly charge the battery as needed.

FIG. 14 is a simplified schematic view of a cart-mounted mobile welding system 1400 including a charging station capable of charging a battery of the welding system in accordance with an example embodiment. With reference to FIG. 14, the cart-mounted mobile welding system 1400 may include many of the same or similar elements arranged and operating in the same or similar fashion as previously described with respect to the cart-mounted mobile welding system 200 of FIGS. 2-10. Accordingly, some features of the cart-mounted mobile welding system 1400 may be described briefly or otherwise omitted in the following description to avoid obscuring more pertinent features of the embodiment with the understanding that features described with reference to cart-mounted mobile welding system 200 of FIGS. 2-10 may also apply to cart-mounted mobile welding system 1400.

Briefly, the cart-mounted mobile welding system 1400 includes a cart 1402 supporting a welding machine 1418 (also known as a welding power source or weld controller) on a surface thereon, and a battery energy storage unit 1420 mounted to or otherwise supported on or by the cart 1402, the battery energy storage unit 1420 operable to deliver electrical power to the welding machine 1418 via a power cord 1404 (e.g., a 240V power cord). The cart 1402 has the same or similar features as the cart 202 of FIG. 2. Likewise, the welding machine 1418 and the battery energy storage unit 1420 have the same or similar features as the respective welding machine 218 and the battery energy storage unit 220 of FIG. 2. These components are designed to operate in a similar fashion as described with reference to the previous example embodiment of the cart-mounted mobile welding system 200. As illustrated in FIG. 14, the cart-mounted mobile welding system 1400 includes a power cord 1406 (e.g., a 110V power cord) coupled to an external power source (not shown) and operable to transfer electrical power from the power source to the battery energy storage unit 1420 for charging.

Although the welding systems 200, 1200, 1400 are illustrated with a particular arrangement of the system components and their connections, skilled persons will appreciate that many other physical arrangements of the system components (such as the battery energy storage units 220, 1220, 1420, switching control units 702, conduit 606, and welding machine 218, 1118, 1418, etc.) are possible while providing a stable and mobile welding system 200.

It should be understood that while the figures illustrate an example design for the particular features of the described battery powered welding cart, other configurations may be possible without departing from the principles of the disclosed subject matter. In addition, although the description above contains much specificity, these details should not be construed as limiting the scope of the disclosed subject matter, but as merely providing illustrations of some embodiments. It should be understood that subject matter disclosed in one portion herein can be combined with the subject matter of one or more of other portions herein as long as such combinations are not mutually exclusive or inoperable.

The terms and descriptions used above are set forth by way of illustration only and are not meant as limitations. It will be obvious to those having skill in the art that many changes may be made to the details of the above-described embodiments without departing from the underlying principles of the disclosed subject matter.

What is claimed is:

1. A welding system comprising:
a cart including a work surface and a plurality of wheels;
a battery energy storage unit supported on the cart;
a welding machine supported on the cart;
a switching control unit supported on the cart, the switching control unit being electrically coupled to the battery energy storage unit and controlling an output of the battery energy storage unit coupled to the welding machine; and
a power input receptacle supported by the cart, the power input receptacle being electrically coupled to the switching control unit and adapted to receive a power coupling to an external power source for charging the battery energy storage unit.

2. The welding system of claim 1, further comprising a disconnect switch interposed between the power input receptacle and the switching control unit, the disconnect switch operable for disconnecting the battery energy storage unit from the power input receptacle when not connected to the external power source.

3. The welding system of claim 1, wherein the welding machine comprises an orbital welding machine with an orbital welding head coupled to a welding power supply via an adapter extension cable.

4. The welding system of claim 1, further comprising a hanger attached to the cart for hanging an adapter extension cable of the welding machine.

5. The welding system of claim 4, wherein the hanger includes a handle for maneuvering the cart.

6. The welding system of claim 4, wherein the hanger extends outwardly beyond the switching control unit to protect the switching control unit from collisions.

7. The welding system of claim 1, wherein the battery energy storage unit includes an armored housing.

8. The welding system of claim 7, wherein the armored housing includes one or more vents allowing for airflow through the battery energy storage unit.

9. The welding system of claim 7, further comprising an emergency fire suppression system located within the armored housing.

10. The welding system of claim 9, wherein the emergency fire suppression system emits a flame retarding agent in response to detecting a fire in the battery energy storage unit.

11. The welding system of claim 10, wherein the flame retarding agent is an aerosol or smothering foam.

12. The welding system of claim 1, wherein the battery energy storage unit has an energy storage capacity in excess of 10 kWh.

13. The welding system of claim 12, wherein the energy storage capacity of the battery energy storage unit is between 13 kWh and 20 kWh.

14. The welding system of claim 12, wherein the battery energy storage unit has a peak output power capacity of at least 10 kW and a continuous output power capacity of at least 5 kW.

15. The welding system of claim 12, wherein the battery energy storage unit has a maximum continuous current output of at least 20 amps.

16. The welding system of claim 1, further comprising an automatic shut-off switch that disconnects the battery energy storage unit from the welding machine when a remaining energy stored in the battery energy storage unit is less than 20% of its maximum energy storage capacity.

17. The welding system of claim 1, wherein the power input receptacle is mounted to the cart.

18. The welding system of claim 17, wherein the cart includes a plurality of panels, and wherein the power input receptacle is mounted to the cart along one or more panels of the plurality of panels.

19. The welding system of claim 1, wherein the power input receptacle and the switching control unit are integrated into a single system.

20. The welding system of claim 1, wherein the cart further includes a cabinet, and wherein the power input receptacle is housed within the cabinet.
